(19) United States
(12) Patent Application Publication
(10) Pub. No.: US 2022/0164221 A1
(43) Pub. Date: May 26, 2022

(54) PRESERVING PERSISTENT LINK CONNECTIONS DURING A CLOUD-BASED SERVICE SYSTEM UPGRADE

(71) Applicant: MOTOROLA SOLUTIONS, INC., Chicago, IL (US)

(72) Inventors: Pawel Antemijczuk, Soborg (DK); Fernando Casanova Galeano, Greve (DK)

(21) Appl. No.: 17/101,499

(22) Filed: Nov. 23, 2020

(51) Int. Cl. G06F 9/48; H04L 29/08; G06F 9/54

(52) U.S. Cl. CPC G06F 9/4843; H04L 67/10; G06F 9/546; H04L 67/34; H04L 67/143; H04L 67/141

(57) ABSTRACT

A method and a microservice system for preserving link connections during an upgrade. The system a memory and an electronic processor. The processor is configured to initiate a client process upgrade for a first instance of a plurality of instances, each configured to establish and maintain a link connection between at least one of a plurality of electronic endpoint devices, store state data regarding the link connection between the first instance and an electronic endpoint device, and instantiate, for the first instance, an upgraded instance of the link adapter service. The processor is configured to shut down the first instance, causing the first instance to terminate the link connection to the endpoint device, and immediately establish a new link connection between the endpoint device and the upgraded instance, a state of the new link connection being established according to the stored state data.

### BACKGROUND OF THE INVENTION

Microservices are provided in a computing architecture, in which each application of the computer architecture is decomposed into a plurality of different, smaller services (microservices). Each of these microservices runs its own application processes and communicates with light-weight mechanisms (for example, application program interfaces (APIs)). Because microservices are implemented and deployed independently of each other as independent processes, they may be monitored and scaled independently while facilitating continuous delivery and deployment. Existing monolithic software applications, for example, emergency call/message handling applications, have been modified to be implemented as microservices.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a microservice system in accordance with some embodiments.

FIG. 2 is a diagram of a controller in which the microservice system of FIG. 1 may be implemented, in accordance with some embodiments.

FIG. 3 is a flowchart of a method of preserving link connections during a cloud-based service system upgrade performed via the system of FIG. 1, in accordance with some embodiments.

FIG. 4 is a diagram of the microservice system of FIG. 1 following implementation of the method of FIG. 3, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

In a microservice-based architecture, incoming messages are delivered to an available instance of a service provided by the architecture based on load-sharing (a load balancer). New instances of the service may be created or added as needed when the incoming service request/message load increases, when instances fail, or a combination thereof. The frameworks for implementing a microservice architecture may be designed for stateless services (for example, representational state transfer (REST) web applications), where each service instance is stateless and, thus, fully interchangeable. It may be advantageous to implement stateful services on such frameworks.

Microservices may be adapted for a number of different services involving persistent connections between a core server and a plurality of client systems. In such persistent connection microservice systems, it is beneficial or even critical to maintain the communication link between the core server and the client systems or device(s). For example, in the case of a cloud-based land mobile radio (LMR) microservice architecture, an LMR core supports and maintains a plurality of communication links to a plurality of LMR base sites that are intended to be persistent.

During the course of running a microservice-based architecture in a system, it may be desirable to perform an upgrade (firmware, hardware, software, or some combination thereof) to the system. While an upgrade may be desired for improving the system, performing the upgrade may require a restart or shut down of one or more service instances of the system, causing downtime, a disruption of service on the client side, or both. In the cloud-based LMR microservice system example described above, an upgrade of the system may result in a loss of communication links to one or more base sites, which causes the base sites to drop to site trunking and forces the base sites to reconnect to the core. This temporary loss of service would cause radio users to be unable to reach the dispatchers and users located at other LMR sites until reconnection is complete and links are back to wide trunking. Thus, there is a need to prevent such connection and service losses.

Accordingly, systems and methods described herein are directed to, among other things, preserving link connections with endpoints during a cloud-based service system upgrade.

One embodiment provides a method for preserving link connections during a service system upgrade. The method includes initiating, at an electronic processor, a client process upgrade for a first instance of a plurality of instances of a link adapter service executed by the electronic processor, storing, at a memory, state data regarding a link connection between the first instance and an electronic endpoint device, and instantiating, for the first instance, an upgraded instance of the link adapter service. The method further includes shutting down the first instance, causing the first instance to terminate the link connection to the electronic endpoint device, and immediately establishing a new link connection between the electronic endpoint device and the upgraded instance, a state of the new link connection being established according to the stored state data.

Another embodiment provides a service system for preserving link connections during an upgrade. The system includes a memory and an electronic processor communicatively coupled to the memory. The electronic processor is configured to initiate a client process upgrade for a first instance of a plurality of instances of a link adapter service, each instance configured to establish and maintain a link connection between at least one of a plurality of electronic endpoint devices, store, at the memory, state data regarding the link connection between the first instance and an electronic endpoint device, and instantiate, for the first instance, an upgraded instance of the link adapter service. The processor is further configured to shut down the first instance, causing the first instance to terminate the link connection to the endpoint device, and immediately establish a new link connection between the electronic endpoint device and the upgraded instance, a state of the new link connection being established according to the stored state data.

Before embodiments are explained in detail, it is to be understood that the invention is not limited in its application to the details of construction and the arrangement of components set forth in the following description or illustrated in the following drawings. The invention is capable of other embodiments and of being practiced or of being carried out in various ways. For example, although the examples described herein are in terms of cloud based LMR systems, in other embodiments, the methods described herein may be applied to different applications (for example, call management/handling applications).

For ease of description, some of the example systems presented herein are illustrated with a single exemplar of each of its component parts. Some examples may not describe or illustrate all components of the systems. Other example embodiments may include more or fewer of each of the illustrated components, may combine some components, or may include additional or alternative components.

It should be understood that although the system depicts components as logically separate, such depiction is merely for illustrative purposes. In some embodiments, the illustrated components may be combined or divided into separate software, firmware, and/or hardware. Regardless of how they are combined or divided, these components may be executed on the same computing device or may be distributed among different computing devices connected by one or more networks or other suitable communication means.

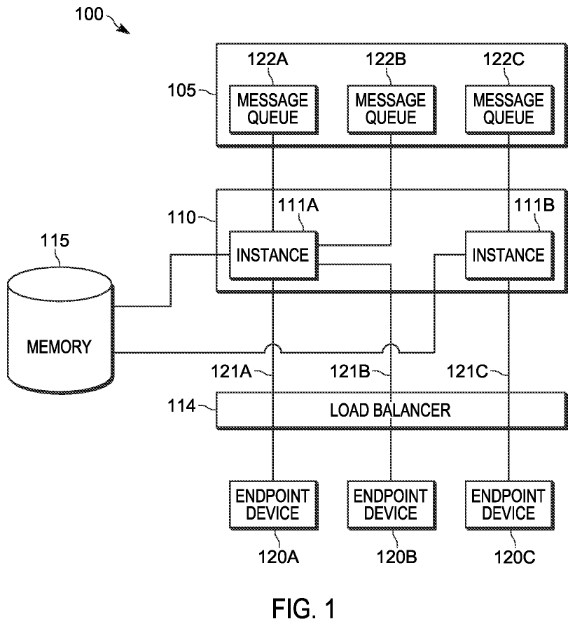

FIG. 1 is a diagram of one embodiment of a microservice system 100. In the example shown, the microservice system 100 includes a message broker 105, an engine tier 110 including a plurality of instances (for example, as illustrated, instances 111A and 111B), a load balancer 114, and a memory 115. The system 100 is configured to communicate with at least one of a plurality of electronic endpoint devices 120A, 120B, and 120C. As described in more detail below, for each endpoint device (in the illustrated embodiment of FIG. 1, endpoint devices 120A-120C), a respective message queue (message queues 122A, 122B, and 122C respectively) is stored within the message broker 105.

The microservice system 100 is configured to create new instances as well as shut down or delete existing instances at any time. For example, the microservice system 100 may create one or more new instances when there are more endpoint devices requesting service than can be handled by the number of existing instances. The microservice system 100 may include any number of instances and endpoint devices and respective message queues. However, for ease of description, only instances 111A-111B and endpoint devices 120A-120C and their respective message queues 122A-122C are illustrated and described herein.

At a hardware level, components of the microservice system 100 may be connected to one another via a wired network, a wireless network, or both. All or parts of the networks used in the microservice system 100 may be implemented using various communication networks, for example, a cellular network, the Internet, a Bluetooth™ network, a wireless local area network (for example, Wi-Fi), a wireless accessory Personal Area Networks (PAN), a machine-to-machine (M2M) autonomous network, and a public switched telephone network. For example, in some embodiments the microservice system 100 is a cloud-based system. The message broker 105, the engine tier 110, the load balancer 114, the memory 115, and other components of the microservice system 100 communicate with each other using suitable wireless or wired communication protocols. In some embodiments, the microservice system 100 includes a single electronic controller or computer (for example, a server) and the message broker 105, engine tier 110, the load balancer 114, and the memory 115 may be hardware and/or software components of the system 100. In some embodiments, the engine tier 110, the load balancer 114, the memory 115, and message broker 105 are each an independent cluster network including one or more servers or computers including one or more processors configured to perform particular functions of the system 100.

The microservice system 100 is configured to receive messages from and transmit messages to one or more of the endpoint devices 120A-120C. In one example, the microservice system 100 is configured to provide one or more services to a target endpoint (for example, a client device, an application, or a system) selected from the endpoint devices 120A-120C. For example, in the illustrated embodiment, the microservice system 100 is configured to provide an LMR cloud communications adapter service (similar to the example described above) for relaying messages from endpoint devices 120A-120C to an LMR core cloud service system and vice versa. In such embodiments, the one or more of the endpoint devices 120A-120C may include one or more base stations, console sites, or both. In should be understood that, in some embodiments, the microservice system 100 is configured to provide one or more of different services and additional services. Such service(s) may include, but are not limited to, call handling, text message handling, service request handling, and the like. Each of the endpoint devices 120A-120C may communicate with a respective instance 111A and 111B using various communication networks (for example, those described above), wired connections, or some combination thereof.

The load balancer 114 is configured to receive incoming service requests from one or more endpoint devices (for example, endpoint devices 120A-120C) and distribute each to a particular instance of the engine tier 110 for processing or handling. For example, the service requests are distributed to an instance 111A or an instance 111B available and capable of handling the service request. A link connection is then established between the instance 111A or 111B and the respective endpoint device 120A, 120B, or 120C. For example, as illustrated in FIG. 1, endpoint devices 120A and 120B each have a link connection 121A and 121B to the instance 111A, while endpoint device 120C has a link connection 121C to instance 111B. In some embodiments, following the initial establishment of the link connection 121A-121C between the endpoint devices 120A-120C and the respective instance 111A-111B in response to a service request, the respective link connection 121A-121C is maintained following the handling of the service request.

For each endpoint 120A-120C connected to a respective instance 111A-111B, the message broker 105 creates and maintains a respective message queue (for example, as illustrated in FIG. 1, message queues 122A, 122B, and 122C). Each message queue 122A-122C may include one or more service requests relating to one or more services provided by the microservice system 100. Each of the message queues 122A-122C is consumed by only a single instance 111A-111B at a time. For example, as shown in FIG. 1, instance 111A consumes from message queue 122A (corresponding to endpoint device 120A) and message queue 122B (corresponding to endpoint device 120B), while instance 111B consumes from message queue 122C (corresponding to endpoint device 120C). The instances 111A-111B of the engine tier 110 are each configured to process and fulfill each service request of their respective one or more message queues 122A-122C.

For example, in embodiments where the microservice system 100 provides an LMR cloud communications adapter service described above, the service requests of one of the message queues 122A-122C may relate to (i) relaying service messages between a respective endpoint device(s) 120A-120C and the LMR cloud communications adapter service of the microservice system 100, (ii) maintaining a link communication state of each of the endpoint devices 120A-120C (for example, whether an endpoint is using site trunking or wide trunking), and (iii) maintaining LMR resource usage for each endpoint 120A-120C.

The memory 115 is configured to manage process state information (e.g., data corresponding to a service request being handled by the particular instance) for each of the instances 111A-111B for a particular link connection. The memory 115 is configured to maintain in-memory data associated with various link connections of the microservice system 100. When processing a service request, the engine tier 110 may pull state data objects from the memory 115, use the objects, and push them back to the memory 115 after processing is complete. In some embodiments, the memory 115 may include a plurality of memory partitions, each of which correspond to a particular instance 111A-111B. In some embodiments, state information for a particular instance 111A-111B may be replicated between partitions such that, in case of an instance failure, another instance may recover the state information from the replicated information. In some embodiments, the memory 115 is configured to store long-lived (stateful) data objects while the engine tier 110 may be configured to store short-lived (stateless) data objects. For example, each instance 111A-111B may include a respective memory (not shown) for storing state data for a short term.

To help ensure proper workflow and service request handling of the microservice system 100, each instance 111A-111B may initiate and maintain one or more timers. Timer data may be replicated between two or more instances of the engine tier 110. The message broker 105 may also request and access timer data of the engine tier 110, for example, to timely allocate received requests. Timers may be stored on either the engine tier 110 or the memory 115. As described in more detail below, the message broker 105 is further configured to store a time to expire period corresponding to a duration of a timer. In some embodiments, the time to expire periods are stored in either of the engine tier 110 or the memory 115 such that the information is available to one or more instances 111A-111B of the engine tier.

For ease of description, the system 100 is described in terms of a hardware system. It should be understood that, in some embodiments, some or all of the system 100 may be implemented in software as a virtual network system. In other words, the microservice system can be defined as the combination of software and hardware included in one or more electrical computing devices that run application processes of the microservice.

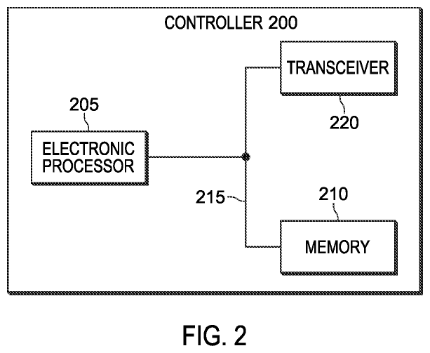

FIG. 2 is a diagram of an electronic controller 200 on which the microservice system 100 may be implemented. The electronic controller 200 may be, for example, a server. In the embodiment illustrated, the controller 200 includes an electronic processor 205 (for example, a microprocessor or the like), a memory 210, and a transceiver 220. The electronic processor 205, the memory 210, the transceiver 220, as well as other various modules (not shown) are coupled by a bus 215. The bus 215 may include one or more wires, traces, fiber optics, or other communication connections that provide one or more direct, dedicated couplings between devices, one or more multiplexed couplings between devices, or combinations thereof. In alternate embodiments, the controller 200 may include fewer or additional components in configurations different from that illustrated in FIG. 2.

The memory 210 includes read only memory (ROM), random access memory (RAM), other non-transitory computer-readable media, or a combination thereof. In some embodiments, the memory 210 is or includes memory 115 of FIG. 1. The electronic processor 205 is configured to retrieve instructions and data from the memory 210 and execute, among other things, instructions to perform the methods described herein.

The electronic processor 205 is configured to control the transceiver 220 to transmit and receive electronic communication signals to and from one or more electronic devices (for example, endpoint devices 120A-120C). In some embodiments, the transceiver 220 is used for communications between one or more components of the microservice system 100. The electronic processor 205 and the transceiver 220 may include various digital and analog components (for example, digital signal processors, high band filters, low band filters, and the like), which for brevity are not described herein and which may be implemented in hardware, software, or a combination of both. In some embodiments, the transceiver 220 includes a combined transmitter-receiver component. In other embodiments, the transceiver 220 includes separate transmitter and receiver components

In some embodiments, the engine tier 110, the load balancer 114, the memory 115, and/or the message broker 105 may all be implemented on a single electronic controller (for example, the electronic controller 200). In some embodiments, one or more of the engine tier 110, the load balancer 114, the memory 115, and/or the message broker 105 is/are implemented on multiple electronic devices that include components or combinations of different components, including all or some of the various components described above with respect to the controller 200 (for example, an electronic processor, memory, and, in some embodiments, a transceiver). As a consequence, these components are not described in detail or explicitly illustrated.

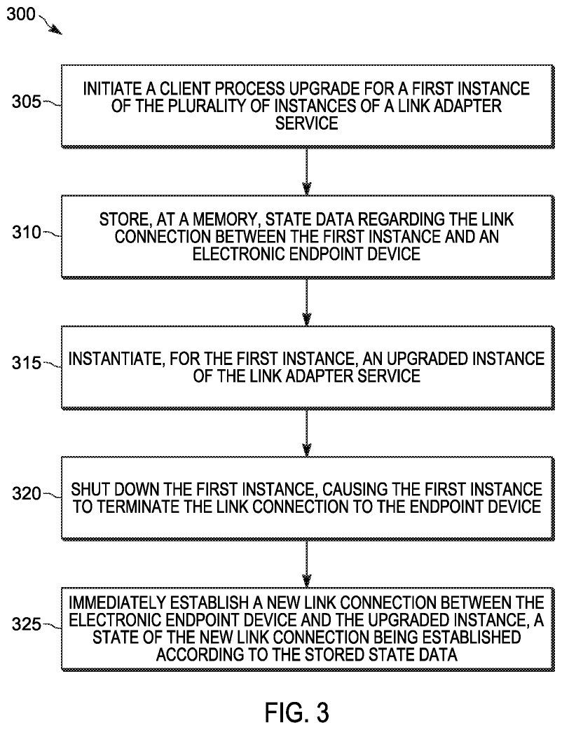

FIG. 3 illustrates an example method 300 for preserving link connections during a cloud-based service system upgrade for a microservice system (for example, system 100). As an example, the method 300 is explained in terms of the controller 200, in particular the electronic processor 205. However, it should be understood that portions of the method 300 may be distributed among multiple devices/components (for example, across multiple processors of the microservice system 100). Similarly, method 300 is explained in terms of instance 111B, endpoint device 120C, and message queue 122C as an example. However, the method 300 may be applied to any other instance and its respective endpoint device(s) and message queues. The method 300 may be implemented for any number of instances at a given time.

In the example illustrated, at block 305, the processor 205 initiates a client process upgrade for a first instance (for example, instance 111B) of the plurality of instances 111A-111B of a link adapter service provided by the microservice system 100 (for example, an LMR service). The client process upgrade is any kind of system upgrade for the microservice system 100 (for example, to correct one or more bugs/defects and/or to add new functionality/features to the system 100). In some embodiments, upon initiating the upgrade of the first instance 111B, the processor 205 may remove the instance 111B as an available option to which the load balancer 114 may direct other endpoint devices (for example, to prevent additional endpoint devices from being directed to the instance 111B for service request fulfillment). The instance 111B may then receive, from the electronic processor 205, a command for the instance 111B to prepare to shut down. In response, the instance 111B ceases consuming messages from the message queues of the endpoint devices to which it has link connections (here, message queue 122C of endpoint device 120C and link connection 121C).

At block 310, the electronic processor 205 stores, at a memory (for example, memory 210 and/or memory 115), state data regarding the link connection 121C between the first instance 111B and an electronic endpoint device (for example, endpoint device 120C). In some embodiments, the state data includes resource usage of the endpoint device 120C, which indicates, for example, an amount of use by the endpoint device 120C relative to a total amount of resources utilized by the microservice system 100 for fulfilling service requests (for example, bandwidth, memory, and the like). In embodiments where the instance being upgraded has link connections with more than one endpoint device (for example, instance 111A of FIG. 1), the state data regarding all link connections between that instance and its respective endpoint devices is stored (for instance 111A, the state data of link connections 121A and 121B of endpoint devices 120A and 120B respectively would be stored). In some embodiments, as described in more detail below regarding block 325, the storing of the state data includes setting and storing a time-to-expire period.

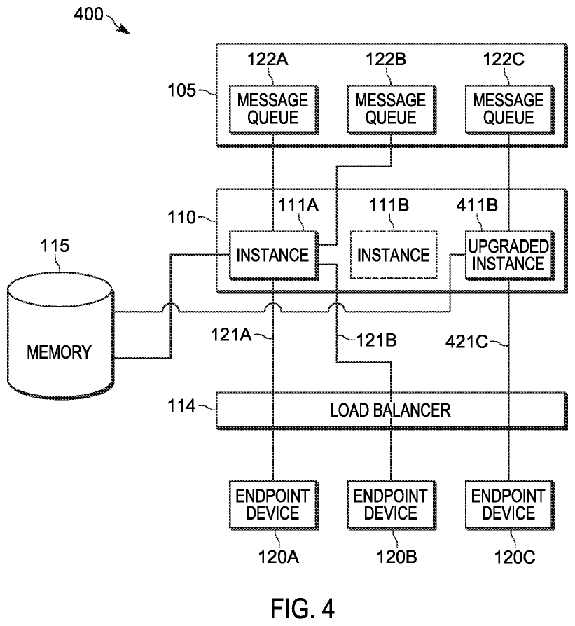

At block 315, the electronic processor 205 instantiates, for the first instance 111B, an upgraded instance of the link adapter service (for example, upgraded instance 411B of FIG. 4). The upgraded instance 411B is an instance that includes the client process upgrade of block 305. Upon instantiation, the upgraded instance 411B serves no endpoint devices.

At block 320, the electronic processor 205 shuts down the first instance 111B, causing the first instance 111B to terminate the link connection 121C to the endpoint device 120C. The instance 111B may be deleted or, in some embodiments, upgraded while not servicing any endpoint devices. In some embodiments, the upgraded instance at block 315 is a previously shut down first instance from a different implementation of the method 300.

At block 325, the electronic processor 205 immediately establishes a new link connection (link connection 421C of FIG. 4) between the electronic endpoint device 120C and the upgraded instance 411B, a state of the new link connection 421C being established according to the stored state data. The new link connection 421C may be establishes as soon as the processor 205 detects that the link connection 121C has been terminated. In some embodiments, a load balancer (for example, load balancer 114) establishes the new link connection 421C to the endpoint device 120C. The state of the new link connection 421C is determined for the upgraded instance 411B based on the originally stored state data of block 310. This allows the upgraded instance 411B to almost seamlessly continue the service request process being performed by the original instance 111B from the state the request process was in just before the client process upgrade was initiated at block 305 of FIG. 3. In some embodiments, the upgraded instance 411B may perform a destructive read of the state data related to the endpoint device 120C and store it in a local short-term memory (not shown). In some embodiments, the processor 205 is further configured to assign the message queue 122C of the first instance 111B to the upgraded instance 411B following shutting down the first instance 111B. The message queue 122C may be the original message queue 122C of the first instance 111B. In some embodiments, the message queue assigned to the upgraded instance 411B is a duplicate queue of the original message queue 122C of the first instance 111B.

In some embodiments, the stored state data may be deleted when the time-to-expire period is exceeded before the endpoint device 120C is reconnected to an upgraded instance 411B following shut down of the instance 111B. This may be done, for example, in order to prevent a loss of synchronization between an actual state of the endpoint device 120C and its state representation according the stored state data. If no state data regarding the link connection 121C between the first instance 111B and the endpoint device 120C is present in the memory 115, the processor 205 may be configured to reset, after a predetermined period of time, the state of the new link connection 421C. This may be done by waiting for the endpoint device 120C itself to reset the state of the link connection 421C or, when not received within a period of time, the processor 205 may notify the endpoint device 120C to initiate the reset.

FIG. 4 illustrates the microservice system 100 of FIG. 1 including the upgraded instance 411B following block 320 of the method 320 (for clarity, the microservice system of FIG. 4 is referred to as microservice system 400). As illustrated, the microservice system 400 includes most of the same elements as those of microservice system 100 of FIG. 1 and, for sake of brevity, only the additional elements of FIG. 4 will be described here.

As shown in FIG. 4, the upgraded instance 411B now maintains the new link connection 421C to endpoint device 120C and accesses the respective message queue 122C for the endpoint device 120C, both the endpoint device 120C and message queue 122C originally being handled by instance 111B, which is herein shut down and/or deleted. As illustrated, instance 111A remains unchanged following the implementation of the method 300 on instance 111B. However, as mentioned above, in further embodiments, the method 300 may be applied to any number of instances of the engine tier 110 at any time, so long as the number of instances being upgraded at a same time is less than the total number of instances of the engine tier 110.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for preserving link connections during a microservice system upgrade, the method comprising:
initiating, at an electronic processor, a client process upgrade for a first instance of a plurality of instances of a link adapter service executed by the electronic processor;
storing, at a memory, state data regarding a link connection between the first instance and an electronic endpoint device;
instantiating, for the first instance, an upgraded instance of the link adapter service;
shutting down the first instance, causing the first instance to terminate the link connection to the electronic endpoint device; and
immediately establishing a new link connection between the electronic endpoint device and the upgraded instance, a state of the new link connection being established according to the stored state data.

2. The method of claim 1, the method further comprising assigning a message queue of the first instance to the upgraded instance following shutting down the first instance.

3. The method of claim 1, wherein storing state data regarding a link connection between the first instance and the electronic endpoint device includes setting a time-to-expire period.

4. The method of claim 1, the method further comprising resetting, after a predetermined period of time, the state of the new link connection when there is no state data regarding the link connection between the first instance and the electronic endpoint device present in the memory.

5. The method of claim 1, wherein the upgraded instance establishes the new link connection to the electronic endpoint device via a load balancer.

6. The method of claim 1, wherein the link adapter service is a land mobile radio service.

7. A microservice system for preserving link connections during an upgrade, the system comprising:
a memory; and
an electronic processor communicatively coupled to the memory and configured to
initiate a client process upgrade for a first instance of a plurality of instances of a link adapter service, each instance configured to establish and maintain a link connection between at least one of a plurality of electronic endpoint devices;
store, at the memory, state data regarding the link connection between the first instance and an electronic endpoint device;
instantiate, for the first instance, an upgraded instance of the link adapter service;
shut down the first instance, causing the first instance to terminate the link connection to the endpoint device; and
immediately establish a new link connection between the electronic endpoint device and the upgraded instance, a state of the new link connection being established according to the stored state data.

8. The system of claim 7, wherein the electronic processor is further configured to assign a message queue of the first instance to the upgraded instance following shutting down the first instance.

9. The system of claim 7, wherein storing state data regarding a link connection between the first instance and the electronic endpoint device includes setting a time-to-expire period.

10. The system of claim 7, wherein the electronic processor is further configured to reset, after a predetermined period of time, the state of the new link connection when there is no state data regarding the link connection between the first instance and the electronic endpoint device present in the memory.

11. The system of claim 7, wherein the upgraded instance establishes the new link connection to the electronic endpoint device via a load balancer.

12. The system of claim 7, wherein the link adapter service is a land mobile radio service.
